(19) United States
(12) Patent Application Publication
(10) Pub. No.: US 2008/0121593 A1
(43) Pub. Date: May 29, 2008

(54) Filter System for Water and Waste Water

(75) Inventors: Werner Fuchs, Wien (AT); Robert Vranitzky, Wien (AT); Christoph Lukaschek, Voesendorf (AT)

Correspondence Address: GREENBLUM & BERNSTEIN, P.L.C., 1950 ROLAND CLARKE PLACE, RESTON, VA, 20191, US

(73) Assignee: VA TECH WABAG GmbH, Wien (AT)

(21) Appl. No.: 11/720,597

(22) PCT Filed: Dec. 1, 2005
(86) PCT No.: PCT/EP05/56382

§ 371 Date: Aug. 21, 2007

(30) Foreign Application Priority Data
Dec. 1, 2004 (EP) 2004/013602

(51) Int. Cl. B01D 61/18; B01D 61/20; B01D 65/00

(52) U.S. Cl. 210/767; 210/416.1; 210/407; 210/321.6

(57) ABSTRACT

The invention provides a filter system for water or wastewater, comprising at least one vessel in which there are arranged aerated filter modules (7), at least one feed space (13) being provided for the simultaneous feed of suspension (10) that is to be filtered to the filter modules (7). What is new is that there is a feed distribution space (12), through which suspension (10) that is to be filtered is introduced into the feed space (13), the feed distribution space (12) leading laterally part way around the feed space (13). As a result, less space is required below the filter modules for supplying the suspension.

The invention relates to a filter system in accordance with the preamble of claim 1 and to a method for operating a filter system. The invention can be applied to membrane filter systems; suitable membrane units are in particular membrane tubes, cushion membranes, hollow-fiber membranes or plate membranes.

The Applicant's WO 02/26363 has disclosed a membrane filter system having a filter module, upstream of which there is arranged a gasification unit through which medium can flow; suspension which is to be purified is fed to the filtration module through a flow pipe.

To allow a uniform distribution of the suspension over the filter cross section to be achieved, the flow tube must have a cross section which corresponds to the filter cross section. This is difficult in large-diameter filter systems, since space needs to be provided for the flow tube and its feed below the filter system.

Therefore, it is an object of the invention to provide a filter system which takes up less space below the filter modules for the suspension feed but nevertheless allows the suspension to be distributed uniformly over the filter cross section.

This object is achieved by the filter system as claimed in claim 1.

Here, there is a feed distribution space, through which suspension that is to be filtered is introduced into the feed space, the feed distribution space leading laterally part way around the feed space. The feed distribution space is a flow-calming admission chamber of the feed space. The term laterally means that the feed distribution space is arranged next to the feed space as seen in the direction of flow through the filter system. As a result, no space for the suspension feed is required beneath the feed space. Because the feed distribution space partially surrounds the feed space, it is also ensured that over this width of the feed distribution space the suspension can be correspondingly uniformly distributed. The height of the feed space should be at least 0.75 and at most 1.5 m.

For this purpose, it is in particular possible to provide that to conduct the method the entry velocity to the feed space is at least 0.5 and at most 2.0 m/sec. The volume of the feed distribution space preferably corresponds to 10-50% of the feed space volume. The feed distribution space surrounds at least 20% and at most 70%, in particular between 20% and 40%, of the periphery of the feed space. The larger the diameter of the feed space, i.e. the more filter modules need to be supplied, the greater the proportion of the periphery covered by the feed distribution space. For example, if the filter system or the feed space has a circular cross section, the feed distribution space which is directly adjacent to the feed space can likewise be of corresponding circular design.

According to one embodiment of the invention, a feed line opens out into the feed distribution space at the top side. This allows additional space to be saved below the feed space and/or the feed distribution space. The diameter of the feed line is generally smaller than the diameter of the filter system. The cross section of the feed distribution space is at least sufficiently large for the diameter of the feed line to be enclosed.

It has proven advantageous if the suspension that is to be filtered can penetrate into the feed space from the feed distribution space through a feed distribution opening. This can be achieved by a feed distribution opening which is continuous in the peripheral direction of the feed space in the lower region of the feed space. A single opening of corresponding size means that the risk of the feed distribution opening becoming blocked is low. Of course, it would also be possible to provide a plurality of feed distribution openings.

If the feed distribution opening is arranged in the vicinity of the base of the feed distribution space and of the feed space, the suspension penetrates laterally at the lower end of the feed space and is diverted upward. Therefore, a uniform upward flow is achieved by the time the filter modules are reached.

To ensure uniform distribution of the suspension over the cross section of the feed space, it is possible for the feed distribution opening to extend substantially over the entire width of the feed distribution space.

To generate a turbulent flow in the membrane units, e.g. membrane tubes, it is possible for aeration elements, which add gas bubbles to the suspension that is to be filtered before it enters the filter modules and around which the suspension that is to be filtered can flow, to be arranged in the feed space. To this end, the feed distribution opening should then open out into the feed space below the aeration device. Suitable aerators are standard membrane aerators, such as for example disk, plate or tube aerators.

To enable deposited contaminants to be removed from the feed space of the membrane filter system, it is advantageous to provide a tap-off device, for example a tap-off tube, in the feed distribution space.

One possible embodiment of the invention involves a filter system which has a plurality of filter modules through which medium can flow in parallel, where the vessel is divided into a plurality of spaces by plates disposed perpendicular to the direction of flow through the filter modules, wherein at least one feed space serves to jointly supply a plurality of filter modules with suspension that is to be filtered, at least one space serves to jointly discharge permeate, and if appropriate at least one space serves to jointly discharge retentate. A filter module may comprise a plurality of membrane units of the same type.

To obtain a simple supply of the suspension that is to be filtered to the filter modules, it is possible to form a feed space which encloses at least the inlet-side end faces of all the filter modules and is connected to the individual filter modules for the purpose of feeding in suspension that is to be filtered.

To obtain simple removal of the retentate, it is possible to form a retentate space which encloses at least the outlet-side end faces of all the filter modules and is connected to the individual filter modules for removing retentate.

In the case of a dry arrangement of the membrane filter system, the retentate should be removed uniformly from the retentate space, which can be achieved by the retentate space having at least one discharge line.

If the membrane filter system is placed directly in the suspension that is to be filtered, there is no need for a retentate space. The retentate mixes with the suspension surrounding it after it has left the filter modules.

The invention is explained with reference to the appended

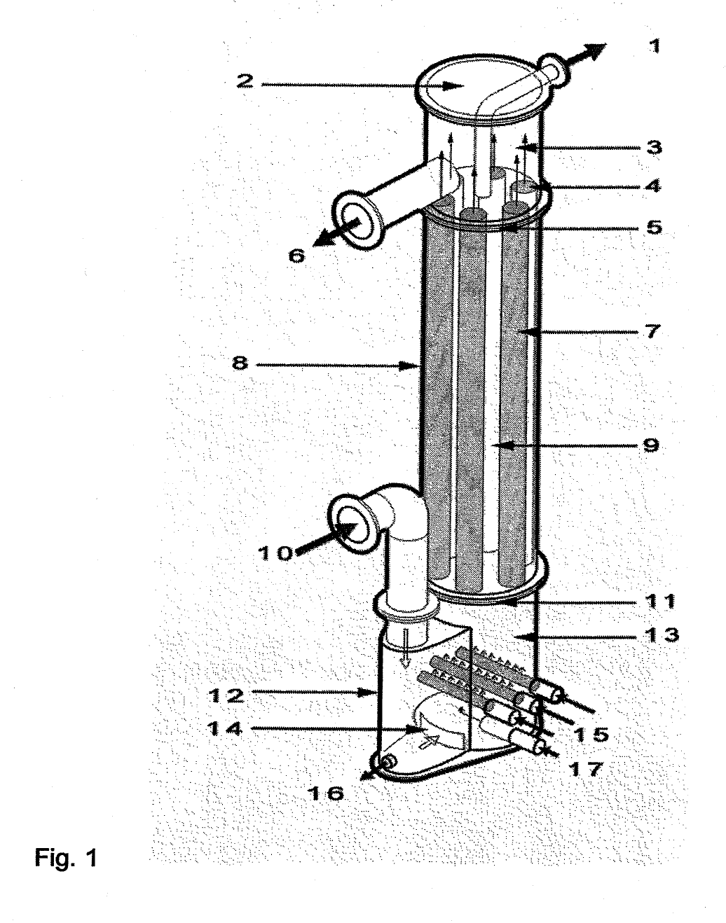

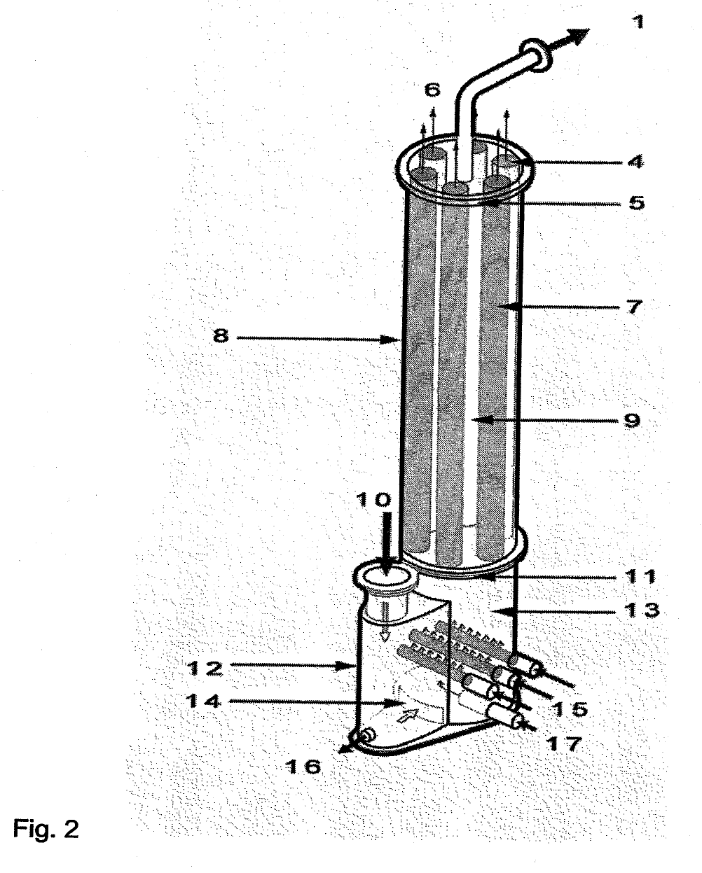

FIGS. 1 and 2, which diagrammatically depict, by way of example, a membrane filter system according to the invention, and the following descriptions. In the drawing:

FIG. 1 shows a membrane filter system with retentate space (for dry mounting),

FIG. 2 shows a membrane filter system without retentate space (for immersed mounting).

It can be seen from FIG. 1 that the filter modules 7 through which medium flows in the direction of flow are arranged parallel and vertical in the permeate space 9, which is sealed off with respect to the feed side. On the inside, this sealed permeate space 9 forms a common permeate space for the filter modules 7, which is connected to a permeate suction pump or to a permeate back-flushing line via a permeate line 1. The permeate space 9 is only in communication with the outside, towards the suspension that is to be filtered, via the membrane surface of the filter modules 7.

Incoming flow which is as far as possible laminar is required in order for a large number of filter modules 7 connected in parallel to be fed uniformly with the suspension that is to be filtered. The feed distribution space 12, which passes the suspension that is to be filtered through a feed distribution opening 14 disposed in the vicinity of the base into the feed space 13, allows uniform flow to all filter modules 7.

In this example, the feed distribution space 12 has a common planar base plate with the feed space 13, the contour of which base plate encloses both the circular cross section of the feed space 13 and the cross section of the imaginary extension of the feed line 10 down to the base plate. The feed distribution space 12 is closed off at the top by a plate that is parallel to the base plate and into which the feed line 10 opens out. The side wall of the feed distribution space 12 starts from the wall of the feed space 13 around the imaginary extension of the feed line 10 and meets the wall of the feed space 13 again at a distance from the other end of the side wall amounting to approximately 25% of the periphery of the feed space 13. The feed distribution space 12 narrows at increasing distance from the feed space 13.

The gasification which is advantageous for the filtration is achieved by means of aeration elements 15 positioned in the feed space 13 beneath the filter modules. The aeration pipes illustrated can be used for this purpose, although other aeration elements are also possible.

To ensure a uniform distribution of gas and suspension over all the small membrane tubes of the filter modules 7, the suspension that is to be filtered has to be mixed with the gas phase in such a way as to ensure optimum distribution over the entire flow tube cross section of the membrane module 8, with the result that sufficient and equal turbulence is realized in each filter module 7. The gasification causes what is referred to as the mammoth pump effect, which assists with the forced transfer of flow and therefore saves energy costs. The aeration elements 15 should produce gasification with medium-sized bubbles in the medium that is to be aerated. For example, for a filtration module 7 with tubular membranes with a diameter of 5 mm, a bubble size of approx. 5 mm should be the aim. One example of a use of a filter module 7 could be a tubular tube module with a diameter of 20 cm and length of 3 m. Approximately 600 tube membranes with a diameter of 5 mm are cast into a pressure casing by means of resin at the top and bottom. Feed space 13 and permeate space 9 are therefore separated from one another in a pressure-tight manner. All the membrane tubes are in communication with one another via the permeate space 9. Permeate can be extracted and/or back-flushed from the permeate space 9 via openings in the pressure casing of the filter module 7.

After it has flowed through the membranes, the retentate passes into a retentate space 3. This retentate space encloses the top of the membrane filter system and is closed off by the retentate cover 2. A tap-off pipe 16 for emptying the membrane filter system is provided at the lowest possible point in the feed distribution space 12. However, the tap-off pipe 16 could also be provided in the feed space 13.

Reliable operation in the long term can only be ensured by completely homogeneous supply to the feed side of the membrane modules. Filtration modules which are insufficiently supplied with cross-flow (slurry and/or air) have a tendency towards excessive build-up of filter cake at the membrane surface. In the most serious circumstances, this filter cake may completely block individual membrane tubes, resulting in an irreversible loss of membrane surface area.

### Removal of Contaminants:

Operating faults often occur in filter systems as a result of plugs formed by hairs, fibers or other contaminants. The cross-flows cause these plugs to be deposited at the locations where the passage width is smallest. Since in the majority of the configurations of the system these locations are formed by the feed passage of the filter modules 7, the contaminants accumulate there. Ever larger conglomerates build up as a result of turbulence. The controlled drainage of the suspension out of the overall membrane filter system combined, at the same time, with back-flushing makes it possible to reliably remedy this problem, since the conglomerated contaminants are in this way discharged from the membrane filter system. In the case of suspensions with a high level of contaminants, it is advantageous for the suspension which is tapped off from the tap-off pipe 16 to have the contaminants removed from it via an external screen, and then for this suspension to be fed back into the filtration circuit.

### Immersed Variant of the Membrane Filter System:

The overall membrane filter system may be in a dry arrangement, i.e. outside a filtration tank. However, as illustrated in FIG. 2, an immersed variant is also possible, since the membrane filter system is, after all, closed off with respect to the outside. In this case, the feed pump can deliver direct from the suspension vessel into the feed distribution space 12. In the immersed embodiment, the retentate space 3 is actually obsolete. The retentate becomes mixed with the suspension after leaving the filter modules. A permeate space 3 that can be blocked off may be required only in the case of chemical purification steps with the exclusion of suspension (cf. Chemische Reinigung [Chemical Purification]). Another possible option for the hydraulic separation of suspension vessel and retentate space is lowering of the suspension vessel level. This can be achieved by slightly concentrating the suspension by means of the filtration unit.

A plurality of membrane filter systems can be arranged next to one another without any connection or may also be connected to one another, for example by virtue of them having a common permeate buffer tank.

### Maintenance of the Filter Modules:

It is necessary to exchange or carry out maintenance on the filter modules 7 after relatively long intervals of time. For this purpose, the feed space 13 and the retentate space 3 are connected to the membrane part via flange 5 and flange 11. Maintenance or exchange can be carried out on the membrane module 8 by opening these connections.

### Production Phase:

During filtration, a suspension pump, which is not shown, and a fan, which is likewise not shown, (via the aeration device 15) produce cross-flow over the membrane surface in the filter modules 7 in order to control the build-up of a covering layer resulting from the formation of filter cakes. A permeate suction pump delivers the permeate through the membrane into a permeate buffer tank. This production state is interrupted by cleaning measures either at defined, periodic intervals or as a result of defined trans-membrane pressure limits being exceeded.

### Back-Flushing and Cleaning Phase:

A number of methods are possible for cleaning the membrane filter system, with different benefits.

A first method, which is very simple to carry out, is characterized in that to clean the membrane filter system, permeate is back-flushed through the permeate line 1 and the membrane surface, counter to the production direction, at periodic intervals of time.

In combination with the gasification unit, it is possible to implement a further highly advantageous cleaning method by at least introducing a cyclical blast of air through the pressure tube (air pulse line) 17 into the filter modules 1 and if appropriate simultaneously back-flushing permeate that has already been obtained through the permeate line 1 and the membrane surface counter to the production direction, in order to clean the membrane filter system. This results in very particularly thorough flushing of the membrane tubes.

The benefits of the individual methods can very particularly advantageously be combined by using a combination of different cleaning methods to clean the membrane filter system.

In the method for removing contaminants described below, the blocking device in the tap-off pipe 16 is opened and a tapping pump is started up. Advantageous removal of the contaminants results if the suspension pump is not running during the tapping phase. This allows particles which otherwise continue to adhere to the inlet openings of the filter modules 7 as a result of the pressure exerted by the flow of suspension to be removed from the feed space 13. A method for the particularly efficient removal of contaminants results from simultaneous back-flushing of the filter modules 7. Permeate, driven by the force of gravity in the feed spaces of the filter modules 7, flows into the feed space 13 and additionally cleans off any contaminants.

Another form of cleaning, the chemical cleaning, of the membrane in the membrane filter system is particularly efficient if it is carried out during exclusion of the suspension that is to be filtered. For this purpose, the blocking devices of the supply passage 10 and the blocking device of the tap-off passage 6 are closed, and the suspension that is to be filtered is removed from the feed space 13 of the membrane filter system by means of a pump and a tap-off pipe 16 arranged in the vicinity of the base. A flushing step which is initiated by the back-flushing of permeate through the permeate line 1, and which takes place particularly advantageously as a result of the continuous gasification (pressure tube and aeration device 15) with the filtration air, is responsible for initial preliminary cleaning of the membrane surface. The contaminated purging water has to be pumped out. Then, the membrane filter system is filled again, with one or more chemical cleaning solutions being added to the back-flushed permeate by means of a metering pump. The aeration with filtration air and the observance of a certain reaction time and reaction temperature results in efficient regeneration of the membrane.

It is possible to prevent the membrane tubes from becoming blocked by means of the various method techniques, such as the permeate back-washing or the air pulsing into the feed space 13 or also the feed line (—the flow pipe supplying the suspension). In general, however, the more uniform the supply of feed slurry and filtration air to the parallel filter modules, the more stable the process.

### Gasification with Purging Air:

The required turbulent flow is generated, according to the invention, by a circulation pump (suspension pump), which pumps the suspension that is to be filtered through the filter modules 7, and is additionally increased by the gasification, which is of benefit to the economics of a membrane filter system of this type, since this reduces the amount of energy which has to be introduced for the circulation pump, with gas being introduced into the suspension just before it enters the filter module. As an additional effect, as a result of the air being blown into the feed passage, it is possible to enrich the levels of oxygen in the suspension that is to be filtered, on account of the fine bubbles and the high level of turbulence in the membrane tubes, so that in the case of activated sludge some of the quantity of oxygen which is in any case required for the carbon or nitrogen breathing can already have been provided by the filtration.

The method provides for the suspension to be gasified in such a way that the pressure difference Δp between inlet and outlet of the filter module is reduced or drops to zero, after the hydrostatic pressure of the liquid column of the suspension in the filter module has been taken into account. This makes it possible to set the flow in the membrane tubes in such a way that an ideal or at least improved pressure profile is achieved in the membrane tubes, which increases both the efficiency and the reliability of production. The principle of the method has already been explained in WO 02/26363.

### Membrane Filter Module:

In principle, it is possible to use all filter modules with “Inside-Outside Filtration” (the liquid that is to be filtered flows through a defined feed passage which is surrounded by a membrane), such as for example tube modules or cushion modules, in the membrane filter system described. One example of a use of a filter module could, as mentioned, be a tubular tube module with a diameter of 20 cm and a length of 3 m. Approximately 600 tube membranes with a diameter of approx. 5 mm are cast into a pressure casing by means of resin at the top and bottom. Feed space and permeate space are therefore separated from one another in a pressure-tight manner. All the membrane tubes are in communication with one another via permeate space. Permeate can be extracted and/or back-flushed from the permeate space via openings in the pressure casing.

The pressure casing of tube modules is actually obsolete for use in the membrane filter system described, since it is replaced by the common permeate space for all the modules. If the membrane material of the tube membranes has a limited mechanical stability, damage may easily occur during storage, assembly or dismantling. In this case, or if the pressure casing cannot be omitted on account of only tube modules with an integrated pressure casing being available, the pressure casing at least does not present any obstacle to the process. Depending on the quantity of permeate or back-flush, it may even be appropriate for the pressure casing of the tube membranes to be used, as it were, as a control wall preventing excess local flow through the membrane. Disproportionate removal of permeate or back-flushing result if the tapping or the application to the permeate space takes place via only one permeate line and high flow rates, with associated hydraulic friction losses, occur at the point of entry into the permeate space.

However, the use of filter modules with outside-inside filtration modules (the membrane is immersed in the liquid that is to be filtered and the permeate extracted from hollow fibers or pockets) is also possible, provided that these modules can be fitted in flow pipes. Furthermore, devices for common feed and air supply as well as a communicating permeate space, have to be created.

The membrane filter system according to the invention has the following advantages over conventional arrangements:
A large number of vertically positioned, aerated filtration modules can be operated in parallel without the likelihood of blockages and without the associated interruptions to operation.
The aeration device for mixing the feed stream with gas bubbles allows a uniform supply to a large number of filter modules.
Contaminants which enter the filtration together with the suspension that is to be filtered may, depending on the hydraulic conditions and the configuration of the membrane filtration modules, either settle directly or join together to form larger assemblies through accumulation. In particular fibers which cannot be retained without residues even using complex preliminary cleaning methods lead to disruption to operation in filtration stages. A tap-off pipe at the lowest point in the membrane filter system allows such deposits to be discharged if present. Irreversible loss of membrane surface area can be avoided, and it is thereby possible to ensure uniform flow to all the membrane filtration modules.
Membranes have to be chemically cleaned at different intervals. The most efficient cleaning is in this case to apply chemical cleaner to the entire membrane surface, both from the feed side and the permeate side. However, the liquid that is to be filtered should advantageously be removed from the membrane filter system for this purpose. With the invention described here, it can be separated from the feed tank holding the suspension that is to be filtered by means of blocking devices. An emptying pump empties the entire apparatus without any residues, then purges it with permeate, followed by cleaning using the appropriate chemical cleaning method. The compact membrane filter system has a relatively small feed-side and permeate-side volume, so that it is possible to reduce the consumption of chemical cleaning agent compared to conventional filtration arrangements.
The compact membrane filter system can be set up even where very little space is available.
The membrane filter system can be either dry or immersed in the liquid that is to be filtered.
On account of its size, the compact membrane filter system is more portable and can be pre-assembled in a factory, resulting in lower final assembly and transport costs.
The compact arrangement of the membrane filter system requires less tube and fitting material for feed, permeate and air lines and therefore also entails lower investment costs than conventional filtration arrangements.

### LIST OF REFERENCE NUMERALS

1. Permeate line
2. Retentate cover
3. Retentate space
4. Filter module end face
5. Retentate space/membrane module flange
6. Retentate line
7. Filter module
8. Membrane module
9. Permeate space
10. Feed line
11. Feed space/membrane module flange
12. Feed distribution space
13. Feed space
14. Feed distribution opening
15. Aeration device
16. Tap-off device
17. Air pulse line

1-12. (canceled)

13. A filter system for water and wastewater, comprising at least one vessel in which there are arranged aerated filter modules (7), at least one feed space (13) being provided below the filter modules for the simultaneous feed of suspension that is to be filtered to the filter modules (7), characterized in that there is a feed distribution space (12) as flow-calming admission chamber of the feed space, through which suspension that is to be filtered is introduced into the feed space (13), the feed distribution space (12) being arranged laterally next to the feed space as seen in the direction of flow through the filter system, leading laterally part way around the feed space (13) and partially surrounding the feed space (13), and the suspension that is to be filtered being able to penetrate into the feed space (13) from the feed distribution space (12) through one or several feed distribution openings (14), the feed distribution space (12) being enlarged compared to the diameter of the feed line (10), the feed distribution space (12) surrounding at least 20% and at most 70%, in particular between 20% and 40%, of the periphery of the feed space (13). the feed distribution opening (14) being arranged in the vicinity of the base of the feed distribution space (12) and of the feed space (13), and the feed distribution opening (14) extending substantially over the entire width of the feed distribution space (12).

14. The system as claimed in claim 1, characterized in that the height of the feed space (13) is at least 0.75 and at most 1.5 m.

15. The system as claimed in claim 1, characterized in that the feed distribution space (12) at least has a volume of 10-50% of the feed space (13).

16. The system as claimed in claim 1, characterized in that a feed line (10) opens out into the feed distribution space (12) at the top side.

17. The system as claimed in claim 1, characterized in that an aeration device (15), around which the suspension that is to be filtered can flow, is arranged in the feed space (13).

18. The system as claimed in claim 1, characterized in that the feed distribution opening (14) opens out into the feed space (13) below the aeration device (15).

19. The system as claimed in claim 1, characterized in that a tap-off device (16) for emptying the filtration device and/or for removing contaminants is provided in the feed distribution space (12).

20. The system as claimed in claim 1, characterized in that it has a plurality of filter modules (7) through which medium can flow in parallel, the vessel is divided into a plurality of spaces by plates disposed perpendicular to the direction of flow through the filter modules (7), wherein at least one feed space (13) serves to jointly supply a plurality of filter modules (7) with suspension that is to be filtered, at least one space (9) serves to jointly discharge permeate (1), and if appropriate at least one space (3) serves to jointly discharge retentate (6).

21. The system as claimed in one of claim 1, characterized in that a filter module (7) comprises a plurality of membrane units of the same type.

22. A method for operating the system as claimed in claim 1, characterized in that the entry velocity of the suspension as it passes from the feed distribution space (12) into the feed space (13) is at least 0.5 and at most 2.0 m/sec.
